(19) United States
(12) Patent Application Publication
(10) Pub. No.: US 2013/0129240 A1
(43) Pub. Date: May 23, 2013

(54) IMAGE CODING APPARATUS, METHOD FOR CODING IMAGE, AND PROGRAM, AND IMAGE DECODING APPARATUS, METHOD FOR DECODING IMAGE, AND PROGRAM

(71) Applicant: CANON KABUSHIKI KAISHA, Tokyo (JP)

(72) Inventor: Masato Shima, Tokyo (JP)

(73) Assignee: CANON KABUSHIKI KAISHA, Tokyo (JP)

(21) Appl. No.: 13/675,956

(22) Filed: Nov. 13, 2012

(30) Foreign Application Priority Data
Nov. 18, 2011 (JP) 2011-252924

(51) Int. Cl. G06T 9/00

(52) U.S. Cl. CPC G06T 9/004
USPC 382/233; 382/238

(57) ABSTRACT

An image processing apparatus according to the present invention includes an image coding apparatus including a first encoding unit configured to be input with an image having a first resolution, and, on a block basis, perform prediction of a block subjected to coding based on coded pixels to code the image and generate first prediction information indicating a prediction method; a scaling unit configured to scale a first image output from the first coding unit based on a ratio of the first resolution to a second resolution larger than the first resolution, by using a filter determined by the first prediction information, to generate inter-layer pixel prediction reference data; and a second coding unit configured to be input with an image having the second resolution, and, on a block basis, perform prediction based on coded pixels or the inter-layer pixel prediction reference data to code the image.

### BACKGROUND OF THE INVENTION

1. Field of the Invention

The present invention relates to an image coding apparatus, a method for coding an image, and a program therefor, and an image decoding apparatus, a method for decoding an image, and a program therefor. More particularly, the present invention relates to a method for selecting a filter to be used for coding and decoding an image.

2. Description of the Related Art

H.264/MPEG-4 AVC, hereinafter simply referred to as H.264, is known as a coding method for moving image compressed recording (ITU-T H.264 (March 2010) Advanced video coding for generic audiovisual services).

H.264 enables hierarchical coding. In the case of spatial scalability, inter-layer pixel prediction can be used. In the inter-layer pixel prediction, coded pixels in a base layer block are scaled and enhancement layer block pixel prediction is performed. Inter-layer residual prediction can also be used. In inter-layer residual prediction, residual coefficients of a base layer block are scaled and then residual prediction for an enhancement layer block is performed. In the inter-layer pixel prediction, a 4-tap filter discussed in Chapter G.8.6 in H.264 is used for up-scaling. Coefficients of the filter are determined by the ratio of the resolution of base layer images to the resolution of enhancement layer images, and a phase calculated from the pixel position of a target enhancement layer block. Also in inter-layer residual prediction, up-scaling processing through linear interpolation based on the phase angle is performed.

To achieve hierarchical coding having spatial scalability, up-scaling coded pixels in a base layer block having a low resolution and using these coded pixels for enhancement layer block pixel prediction, as in H.264, are assumed to be effective from the viewpoint of coding efficiency. However, performing up-scaling processing without using the image characteristics, as in H.264, prevents an optimum up-scaling method from being applied, causing an issue that the coding efficiency does not improve.

### SUMMARY OF THE INVENTION

The present invention is directed to improving the coding efficiency by using base layer block coding information for up-scaling processing in hierarchical coding.

According to an aspect of the present invention, an image processing apparatus includes an image coding apparatus including a first encoding unit configured to be input with an image having a first resolution, and, on a block basis, perform prediction of a block subjected to coding based on coded pixels to code the image and generate first prediction information indicating a prediction method, a scaling unit configured to scale a first image output from the first coding unit based on a ratio of the first resolution to a second resolution larger than the first resolution, by using a filter determined by the first prediction information, to generate inter-layer pixel prediction reference data, and a second coding unit configured to be input with an image having the second resolution, and, on a block basis, perform prediction based on coded pixels or the inter-layer pixel prediction reference data to code the image.

According to the present invention, a filter to be used is determined based on base layer block coding information for up-scaling processing in hierarchical coding. This enables selecting a filter according to the image characteristics, and further improving the coding efficiency.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of an image coding apparatus according to a first exemplary embodiment.

FIG. 2 illustrates examples of intra prediction directions.

FIG. 3 illustrates an example of a relation between intra prediction directions and filters used for up-scaling processing.

FIG. 4 is a flowchart illustrating base layer coding processing by the image coding apparatus according to the first exemplary embodiment.

FIG. 5 is a flowchart illustrating enhancement layer coding processing by the image coding apparatus according to the first exemplary embodiment.

FIG. 6 is a block diagram illustrating a configuration of an image decoding apparatus according to a second exemplary embodiment.

FIG. 7 is a flowchart illustrating base layer decoding processing in the image decoding apparatus according to the second exemplary embodiment.

FIG. 8 is a flowchart illustrating enhancement layer encoding processing in the image decoding apparatus according to the second exemplary embodiment.

FIG. 9 is a block diagram illustrating a configuration of an image coding apparatus according to a third exemplary embodiment.

FIG. 10 is a block diagram illustrating a configuration of an image decoding apparatus according to a fourth exemplary embodiment.

FIG. 11 is a flowchart illustrating enhancement layer coding processing by the image coding apparatus according to the third exemplary embodiment.

FIG. 12 is a flowchart illustrating enhancement layer decoding processing in the image decoding apparatus according to the fourth exemplary embodiment.

FIG. 13 is a block diagram illustrating an example of a hardware configuration of a computer applicable to the image coding apparatuses and image decoding apparatuses according to the present invention.

### DESCRIPTION OF THE EMBODIMENTS

Various exemplary embodiments, features, and aspects of the invention will be described in detail below with reference to the drawings.

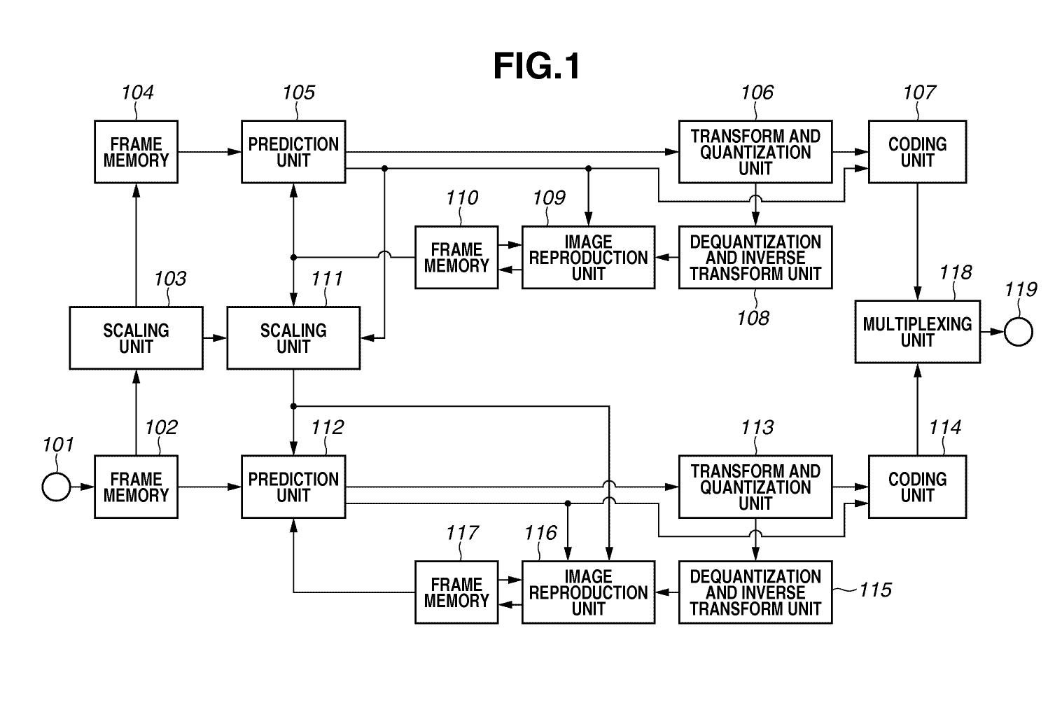

A first exemplary embodiment of the present invention will be described below with reference to the accompanying drawings. FIG. 1 is a block diagram illustrating an image coding apparatus according to the present exemplary embodiment. Referring to FIG. 1, image data is input into a terminal 101. A frame memory 102 stores the input image data on a frame basis. A scaling unit 103 scales input image data at a scaling ratio of n/m (n and m are positive numbers) times. A frame memory 104 stores the scaled image data on a frame basis.

Prediction units 105 and 112 clip the image data in a plurality of blocks and perform intra prediction (in-frame prediction) to generate prediction image data. The prediction units 105 and 112 further calculate prediction errors based on the input image data and the generated prediction image data, and output the calculated prediction errors. Information required for prediction, such as the intra prediction mode, is output together with the prediction errors. Hereinafter, in the present invention, information required for prediction, such as the intra prediction mode, is referred to as prediction information.

Transform and quantization units 106 and 113 orthogonally transform the above-described prediction errors on a block basis to acquire transform coefficients, and further quantize the transform coefficient to acquire quantization coefficients. Coding units 107 and 114 code the quantization coefficients output from the transform and quantization units 106 and 113, and the prediction information output from the prediction units 105 and 112, respectively, to generate coded data. Dequantization and inverse transform units 108 and 115 dequantize the quantization coefficients output from the transform and quantization units 106 and 113 to reproduce the transform coefficients, and further inversely orthogonally transform the transform coefficient to reproduce the prediction errors.

Frame memories 110 and 117 store reproduced image data. Based on the prediction information output from the prediction units 105 and 112, image reproduction units 109 and 116 generate prediction image data suitably referring to the frame memories 110 and 117, respectively. The image reproduction units 109 and 116 further generate reproduction image data based on the prediction image data and the input prediction errors, and output the generated reproduction image data. Based on the prediction information output from the prediction unit 105, a scaling unit 111 scales by filter calculation the image data in the frame memory 110 at a scaling ratio of m/n times which is a reciprocal of that of the scaling unit 103.

The frame memories 104 and 110, the prediction unit 105, the transform and quantization unit 106, the coding unit 107, the dequantization and inverse transform unit 108, and the image reproduction unit 109 code base layer image data. The frame memories 102 and 117, the prediction unit 112, the transform and quantization unit 113, the coding unit 114, the dequantization and inverse transform unit 115, and the image reproduction unit 116 code enhancement layer image data.

A multiplexing unit 118 multiplexes base layer coded data and enhancement layer coded data to form a bit stream. A terminal 119 outputs to outside the bit stream generated by the multiplexing unit 118.

Operations for coding an image by the above-described image coding apparatus will be described below. Although, in the present exemplary embodiment, moving image data is input on a frame basis, still image data for one frame may be input. Although, in the present exemplary embodiment, only intra prediction coding processing will be described below to simplify descriptions, the processing is not limited thereto. The present exemplary embodiment is also applicable to a case where inter prediction coding and intra prediction coding are used together. First of all, operations for coding the base layer image data will be described below.

Image data for one frame is input into the image coding apparatus from the terminal 101, and stores the image data in the frame memory 102. The scaling unit 103 scales the image data stored in the frame memory 102 with a predetermined scaling ratio of n/m (less than 1 in the case of spatial scalability), stores the scaled image data in the frame memory 104, and outputs the scaling ratio to the scaling unit 111.

The prediction unit 105 performs prediction on a block basis to generate prediction errors, and outputs the generated prediction errors to the transform and quantization unit 106. The prediction unit 105 further outputs the prediction information to the scaling unit 111, the image reproduction unit 109, and the coding unit 107. The transform and quantization unit 106 orthogonally transforms the input prediction errors and quantizes the resultant transform coefficients to generate quantization coefficients, and outputs the generated quantization coefficients to the coding unit 107 and the dequantization and inverse transform unit 108.

The coding unit 107 entropy-codes the quantization coefficients generated by the transform and quantization unit 106 and the prediction information input from the prediction unit 105 to generate coded data. Although entropy coding is not limited to a certain method, and may be based on, for example, Golomb encoding, arithmetic encoding, and Huffman encoding. The coding unit 107 outputs the generated coded data to the multiplexing unit 118.

In the meantime, the dequantization and inverse transform unit 108 dequantizes the input quantization coefficient to reproduce the transform coefficients, inversely orthogonally transforms the reproduced transform coefficients to reproduce the prediction errors, and outputs the reproduced prediction errors to the image reproduction unit 109.

Based on the prediction information input from the prediction unit 105, the image reproduction unit 109 reproduces the prediction image suitably referring to the frame memory 110. Then, the image reproduction unit 109 reproduces the image data based on the reproduced prediction image and the prediction errors input from the dequantization and inverse transform unit 108, and stores the image data in the frame memory 110.

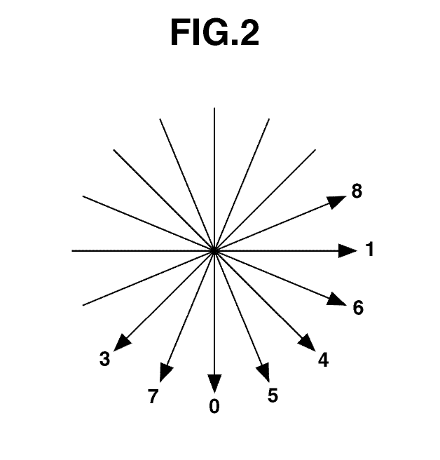

Operations for coding the enhancement layer image data will be described below. Prior to inter-layer pixel prediction by the prediction unit 112, the scaling unit 111 extracts from the frame memory 110 image data at a base layer block position corresponding to an enhancement layer block subjected to coding. The scaling unit 111 scales the extracted base layer image data at a scaling ratio of m/n times, and outputs the scaled image data to the prediction unit 112 as inter-layer pixel prediction reference image data. At this timing, the scaling ratio is input into the scaling unit 111 from the scaling unit 103, the base layer block prediction information is input into the scaling unit 111 from the prediction unit 105, and determines a filter to be used for the scaling processing. In the present exemplary embodiment, the input prediction information is the base layer block intra prediction mode, which indicates one of nine different prediction modes including the eight directions illustrated in FIG. 2 and the DC prediction direction. The method used for base layer block intra prediction is not limited thereto. For example, a new predictive direction may be provided between predictive directions 0 and 5 illustrated in FIG. 2 to perform intra prediction from more predictive directions. In this case, the prediction information input to the scaling unit 111 is also changed according to the above predictive directions.

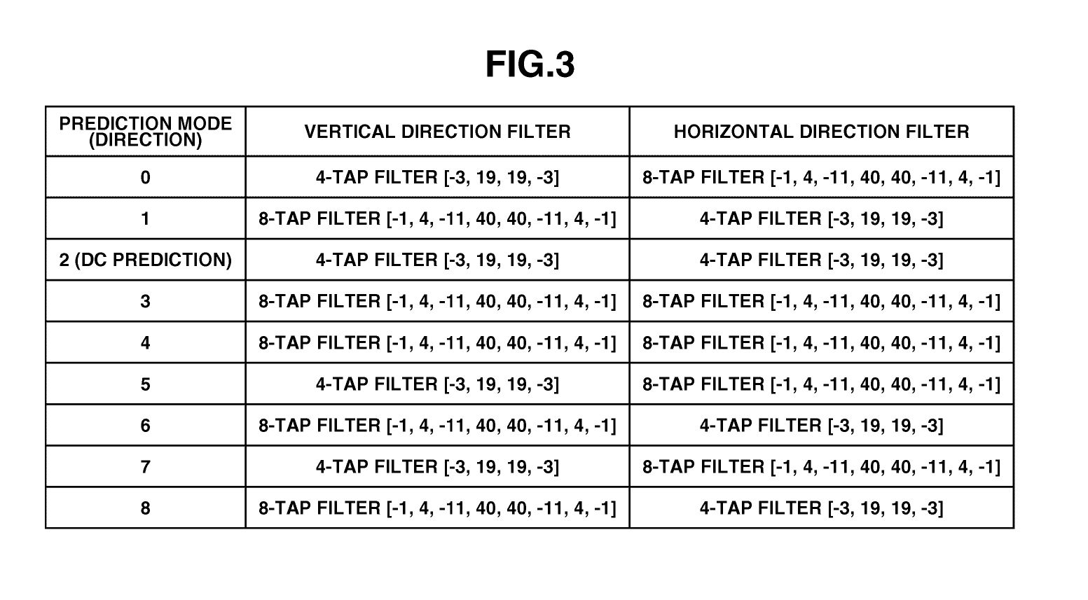

FIG. 3 illustrates a combination of intra prediction modes and filters used for the scaling processing according to the present exemplary embodiment. In the present exemplary embodiment, the scaling ratio m/n is doubled, and the number of coded pixels in the base layer block is doubled for use in enhancement layer prediction. For example, when the base layer block is coded in the prediction mode 0 (vertical direction in FIG. 2), a 4-tap filter [−3, 19, 19, −3] is used for scaling in the vertical direction, and an 8-tap filter [−1, 4, −11, 40, 40, −11, 4, −1] is used for scaling in the horizontal direction. Of course, the combination of intra prediction modes and filters used for the up-scaling processing, and filter types used for the scaling processing are not limited thereto. For example, the present exemplary embodiment may use a filter type in which an edge in a direction parallel to the direction of the intra prediction mode is stored. For filtering with an angle parallel to or close to the direction of the intra prediction mode, the present exemplary embodiment may use a filter having a small number of taps. For filtering with an angle perpendicular to or close to the direction of the intra prediction mode, the present exemplary embodiment may use a filter having a large number of taps. In the above-described example, when the base layer block is coded in the prediction mode 0 (vertical direction in FIG. 2), an edge in the vertical direction is highly likely to exist in the relevant block area. Therefore, the present exemplary embodiment uses a 4-tap filter having a small number of taps for up-scaling in the vertical direction, and an 8-tap filter having a larger number of taps for up-scaling in the horizontal direction.

The prediction unit 112 applies block division to the image data stored in the frame memory 102, and performs intra prediction or inter-layer pixel prediction on a block basis to generate prediction errors. The prediction unit 112 suitably refers to the frame memory 117 when performing intra prediction, and suitably refers to the inter-layer pixel prediction reference image data output from the scaling unit 111 when performing inter-layer pixel prediction. The prediction unit 112 outputs the generated prediction errors to the transform and quantization unit 113, and outputs the prediction information to the image reproduction unit 116 and the coding unit 114.

The transform and quantization unit 113 orthogonally transforms the input prediction errors and quantizes the resultant transform coefficients to generate quantization coefficients, and outputs the generated quantization coefficients to the coding unit 114 and the dequantization and inverse transform unit 115. The coding unit 114 entropy-codes the quantization coefficients generated by the transform and quantization unit 113 and the prediction information input from the prediction unit 112 to generate coded data, and outputs the generated coded data to the multiplexing unit 118.

In the meantime, the dequantization and inverse transform unit 115 dequantizes the quantization coefficients input from the transform and quantization unit 113 and inversely orthogonally transforms the resultant transform coefficients to reproduce the prediction errors. Based on the prediction information input from the prediction unit 112, the image reproduction unit 116 reproduces the prediction image suitably referring to the frame memory 117 and the inter-layer pixel prediction reference image data. Based on the reproduced prediction image and the prediction error input from the dequantization and inverse transform unit 115, the image reproduction unit 116 reproduces the image data, and stores the image data in the frame memory 117. The multiplexing unit 118 multiplexes the coded data based on a predetermined format, and outputs the multiplexed coded data as a bit stream from the terminal 119 to the outside.

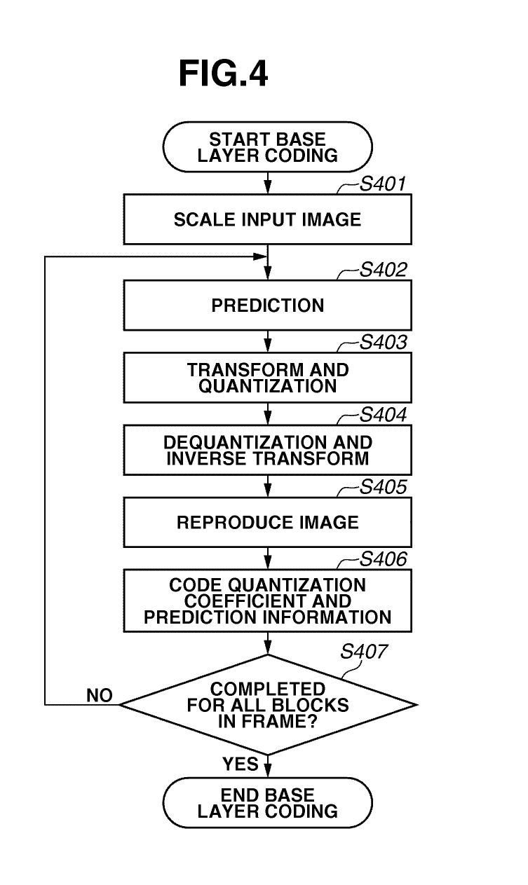

FIG. 4 is a flowchart illustrating base layer encoding processing by the image encoding apparatus according to the first exemplary embodiment.

In step S401, the scaling unit 103 scales the input image data with a predetermined scaling ratio of n/m. In step S402, the prediction unit 105 divides the image data scaled in step S401 in a plurality of blocks, and applies intra prediction (in-frame prediction) to the image data to generate prediction information and prediction image data. The prediction unit 105 further calculates prediction errors based on the input image data and the generated prediction image data. In step S403, the transform and quantization unit 106 orthogonally transforms the prediction errors calculated in step S402 to generate transform coefficients, and quantizes the transform coefficients to generate quantization coefficients. In step S404, the dequantization and inverse transform unit 108 dequantizes the quantization coefficients generated in step S403 and inversely orthogonally transforms the resultant transform coefficients to reproduce the prediction errors.

In step S405, the image reproduction unit 109 reproduces the prediction image based on the prediction information generated in step S402, and further reproduces the image data based on the reproduced prediction image and the prediction errors generated in step S404. In step S406, the coding unit 107 codes the quantization coefficients generated in step S403 and the prediction information generated in step S402 to generate coded data. Step S406 may be executed in any order as long as it is executed after step S403.

In step S407, the image encoding apparatus determines whether encoding is completed for all blocks. If coding is completed for all blocks (YES in step S407), the image coding apparatus ends the base layer coding processing. Otherwise (NO in step S407), the processing returns to step S402 to proceed to the following block.

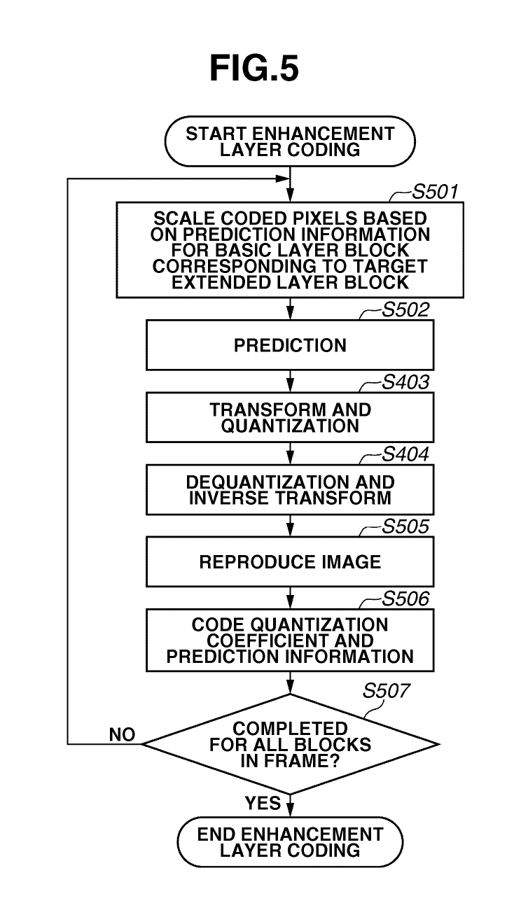

FIG. 5 is a flowchart illustrating enhancement layer encoding processing by the image encoding apparatus according to the first exemplary embodiment. Referring to FIG. 5, steps for implementing equivalent functions to steps in FIG. 4 are assigned the same reference numerals, and redundant descriptions thereof will be omitted.

In step S501, the scaling unit 111 selects a filter to be used for the scaling processing based on the prediction mode for a base layer block corresponding to an enhancement layer block subjected to coding. Then, by using the selected filter, the scaling unit 111 scales coded pixels in the base layer block to generate reference image data for inter-layer pixel prediction.

In step S502, the prediction unit 112 divides input image data in a plurality of blocks, and performs intra prediction (in-frame prediction) or inter-layer pixel prediction referring to the reference image data generated in step S501 to generate prediction information and prediction image data. The prediction unit 112 further calculates prediction errors based on the input image data and the generated prediction image data. In step S505, the image reproduction unit 116 performs intra prediction or inter-layer pixel prediction based on the prediction information generated in step S502 to reproduce the prediction image. Then, the image reproduction unit 116 reproduces the image data based on the prediction image reproduced in this step and the prediction errors reproduced in step S404.

In step S506, the encoding unit 114 codes the quantization coefficient generated in step S403 and the prediction information generated in step S502 to generate coded data. Step S506 may be executed in any order as long as it is executed after step S403. In step S507, the image encoding apparatus determines whether encoding is completed for all blocks. If encoding is completed for all blocks (YES in step S507), the image encoding apparatus ends the enhancement layer encoding processing. Otherwise (NO in step S507), the processing returns to step S501 to proceed to the following block.

Following the base layer coding processing and enhancement layer coding processing, the multiplexing unit 118 multiplexes the base layer coded data generated in step S406 and the enhancement layer coded data generated in step S506 with a predetermined method to generate a bit stream.

With the above-described configurations and operations, in particular, the scaling processing based on the base layer prediction information in step S501 enables using efficient inter-layer pixel prediction for the enhancement layer, thus achieving high-efficient encoding.

An image coding apparatus for the base layer and an image coding apparatus for the enhancement layer may be separately provided. In this case, the scaling units 103 and 111 may be provided outside, or the scaling unit 103 may be provided outside and the scaling unit 111 may be included in the image coding apparatus for the enhancement layer. In this case, images having a plurality of resolutions are input, images having a small resolution are input to the image coding apparatus for the base layer, and images having a large resolution are input to the image coding apparatus for the enhancement layer.

Although examples of filter coefficients selected according to the direction of the intra prediction mode are illustrated in FIG. 3, the number of taps, the filter coefficients, and the filter shape are not limited thereto. For example, a two-dimensional filter may be used. Although, in the present exemplary embodiment, the amount of information of the prediction errors is reduced by using the transform and quantization unit 106, the dequantization and inverse transform unit 108, the transform and quantization unit 113, and the dequantization and inverse transform unit 115, the configuration is not limited thereto. For example, when the quantization parameter is 1, quantization is not performed and the prediction error may be subjected to PCM encoding as it is without transform processing.

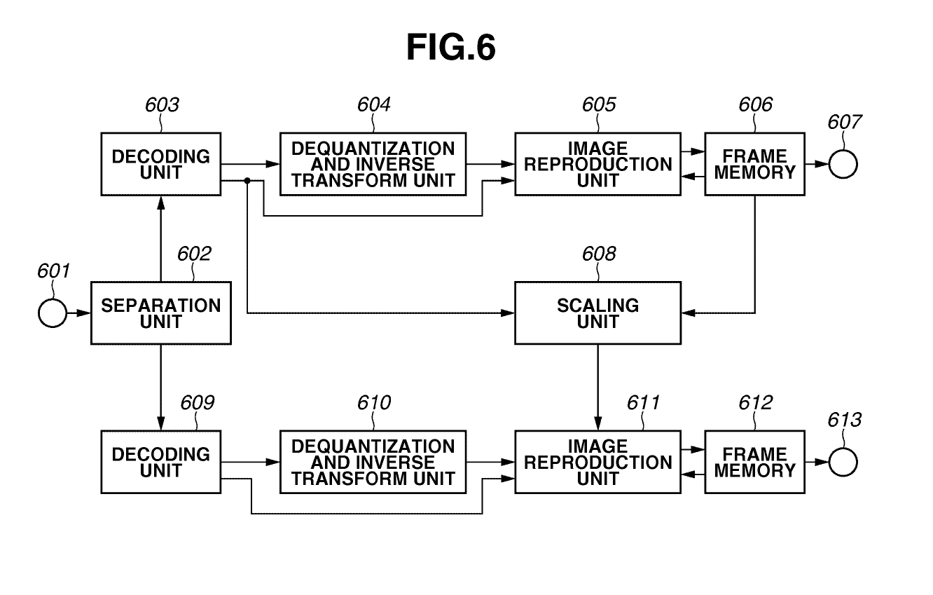

A second exemplary embodiment will be described below. FIG. 6 is a block diagram illustrating a configuration of an image decoding apparatus according to the second exemplary embodiment of the present invention. The present exemplary embodiment will be described below centering on decoding of the coded data generated in the first exemplary embodiment.

A coded bit stream is input into a terminal 601. A separation unit 602 separates the input bit stream into base layer coded data and enhancement layer coded data. The separation unit 602 performs inverse operations of the multiplexing unit 118 illustrated in FIG. 1. Decoding units 603 and 609 separate coded data for each layer into coded data related to the quantization coefficients and coded data related to the prediction information, decode respective coded data to reproduce the quantization coefficients and prediction information, and output the reproduced quantization coefficients and prediction information to the later stage. The decoding units 603 and 609 perform inverse operations of the coding units 107 and 114 illustrated in FIG. 1, respectively.

Similar to the dequantization and inverse transform units 108 and 115 illustrated in FIG. 1, the dequantization and inverse transform units 604 and 610 input the quantization coefficients on a block basis, dequantize the quantization coefficients to acquire transform coefficients, and inversely orthogonally transform the transform coefficients to reproduce the prediction errors. Similar to the image reproduction units 109 and 116 illustrated in FIG. 1, based on the prediction information output from the decoding units 603 and 609, image reproduction units 605 and 611 generate prediction image data suitably referring to frame memories 606 and 612, respectively. Then, the image reproduction units 605 and 611 generate reproduction image data based on the prediction image data and the prediction errors reproduced by the inverse transform units 604 and 610, respectively, and output the generated reproduction image data.

The frame memories 606 and 612 store image data of a reproduced image. A scaling unit 608 scales base layer image data based on the above-described prediction information according to the same scaling ratio as that of the scaling unit 111 illustrated in FIG. 1. A method for calculating the scaling ratio is not particularly limited. The scaling ratio may be calculated based on the ratio of the base layer resolution to the enhancement layer resolution, or on a predetermined setting value.

A terminal 607 outputs the base layer image data, and a terminal 613 outputs the enhancement layer image data. The decoding unit 603, the dequantization and inverse transform unit 604, the image reproduction unit 605, and the frame memory 606 decode the base layer coded data to reproduce the base layer image data. The decoding unit 609, the dequantization and inverse transform unit 610, the image reproduction unit 611, the frame memory 612, and the scaling unit 608 decode the enhancement layer coded data to reproduce the enhancement layer image data.

Operations for decoding an image by the above-described image decoding apparatuses will be described below. In the present exemplary embodiment, the image decoding apparatus decodes the bit stream generated in the first exemplary embodiment.

Referring to FIG. 6, the separation unit 602 inputs the bit stream input from the terminal 601, separates the bit stream into base layer coded data and enhancement layer coded data, and outputs the base layer coded data to the decoding unit 603 and the enhancement layer coded data to the decoding unit 609. First of all, operations for decoding the base layer coded data will be described below.

The base layer coded data is input into the decoding unit 603. The decoding unit 603 decodes header information to separate the coded data into quantization coefficient coded data and prediction information coded data. Then, the decoding unit 603 decodes respective data to reproduce the quantization coefficients and prediction information. The decoding unit 603 outputs the reproduced quantization coefficients to the dequantization and inverse transform unit 604, and outputs the reproduced prediction information to the image reproduction unit 605 and the scaling unit 608. The dequantization and inverse transform unit 604 dequantizes the input quantization coefficients to generate transform coefficients, inversely orthogonally transforms the transform coefficients to reproduce the prediction errors, and outputs the reproduced prediction errors to the image reproduction unit 605.

Based on the prediction information input from the decoding unit 603, the image reproduction unit 605 reproduces the prediction image suitably referring to the frame memory 606. The image reproduction unit 605 reproduces the image data based on the prediction image and the prediction errors input from the dequantization and inverse transform unit 604, and stores the image data in the frame memory 606. The stored image data is used for reference during prediction, and on the other hand, the stored image data is output as base layer image data from the terminal 607.

Operations for decoding the enhancement layer coded data will be described below. Prior to inter-layer pixel prediction by the image reproduction unit 611, the scaling unit 608 extracts from the frame memory 606 image data at a position of a base layer block corresponding to an enhancement layer block subjected to decoding. The scaling unit 608 scales the extracted image data at a scaling ratio of m/n times in response to scaling ratio (n/m), and outputs the scaled image data to the image reproduction unit 611 as inter-layer pixel prediction reference image data. At this timing, the scaling unit 608 inputs the base layer block prediction information from the decoding unit 603, and, similar to the scaling unit 111 in the first exemplary embodiment illustrated in FIG. 1, determines a filter to be used for the scaling processing according to the intra prediction mode.

The enhancement layer coded data is input into the decoding unit 609. The decoding unit 609 decodes header information to separate the coded data into quantization coefficient coded data and prediction information coded data. Then, the decoding unit 609 decodes respective coded data to reproduce the quantization coefficients and prediction information. The reproduced quantization coefficients are input into the dequantization and inverse transform unit 610, and the reproduced prediction information is input into the image reproduction unit 611.

The dequantization and inverse transform unit 610 dequantizes the input quantization coefficients to generate transform coefficients, inversely orthogonally transforms the transform coefficients to reproduce the prediction errors. The reproduced prediction errors are input into the image reproduction unit 611.

Based on the prediction information input from the decoding unit 609, the image reproduction unit 611 reproduces the prediction image, suitably referring to the decoded neighboring pixel data input from the frame memory 612 and the inter-layer pixel prediction reference image data input from the scaling unit 608. The image reproduction unit 611 reproduces the image data based on the reproduced prediction image and the prediction errors input from the dequantization and inverse transform unit 610, and stores the image data to the frame memory 612. The stored image data is used for reference during prediction, and on the other hand, the stored image data is output as the enhancement layer image data from the terminal 613.

Processing for decoding a bit stream by the image decoding apparatus according to the second exemplary embodiment will be described below. Prior to processing, the separation unit 602 executes a certain step (not illustrated) to separate the input bit stream into base layer coded data and enhancement layer coded data. The base layer coded data is decoded by the base layer decoding processing (described below), and the enhancement layer coded data is decoded by the enhancement layer decoding processing (described below).

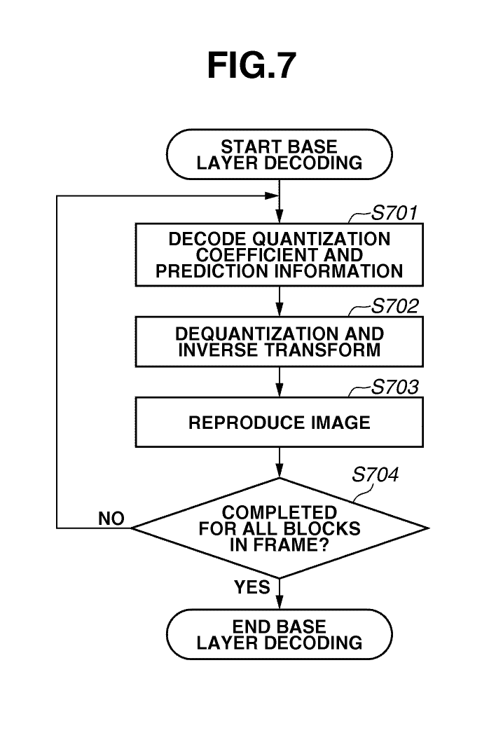

FIG. 7 is a flowchart illustrating the base layer decoding processing by the image decoding apparatus according to the second exemplary embodiment. In step S701, the decoding unit 603 decodes the base layer coded data to reproduce the quantization coefficients and prediction information. In step S702, the dequantization and inverse transform unit 604 dequantizes the quantization coefficients generated in step S701 and inversely orthogonally transforms the resultant transform coefficients to reproduce the prediction errors. In step S703, based on the prediction information generated in step S701, the image reproduction unit 605 performs intra prediction referring to decoded pixels to reproduce the prediction image. Then, the image reproduction unit 605 reproduces the image data based on the reproduced prediction image and the prediction errors reproduced in step S702.

In step S704, the image decoding apparatus determines whether decoding is completed for all blocks. When decoding is completed for all blocks (YES in step S704), the image decoding apparatus ends the base layer decoding processing. Otherwise (NO in step S704), the processing returns to step S701 to proceed to the following block.

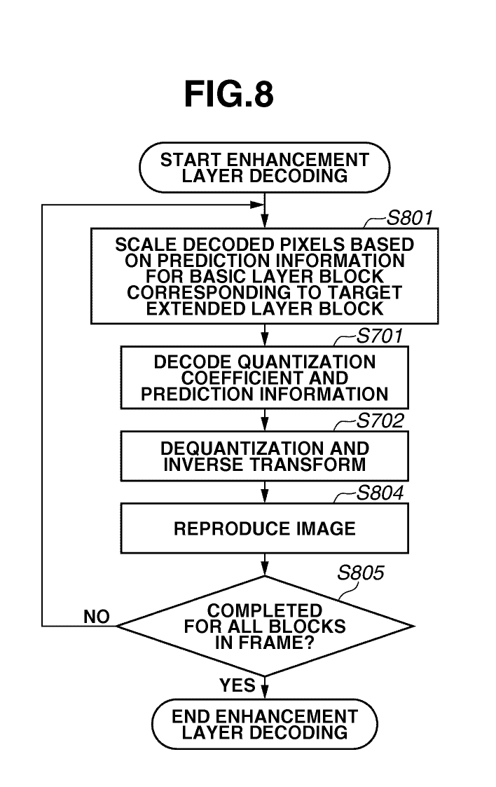

FIG. 8 is a flowchart illustrating the enhancement layer decoding processing by the image decoding apparatus according to the second exemplary embodiment. In step S801, the scaling unit 608 selects a filter to be used for the scaling processing based on the prediction mode for a base layer block corresponding to an enhancement layer block subjected to coding. Then, by using the selected filter, the scaling unit 608 scales decoded pixels in the base layer block to generate inter-layer pixel prediction reference image data for inter-layer pixel prediction.

In step S804, the image reproduction unit 611 performs prediction based on the prediction information generated in step S701 to reproduce the prediction image. In the case of intra prediction, the image reproduction unit 611 reproduces the prediction image referring to decoded pixels. In the case of inter-layer pixel prediction, the image reproduction unit 611 reproduces the prediction image referring to the inter-layer pixel prediction reference image data generated in step S801. Then, the reproduction unit 611 reproduces the image data based on the reproduced prediction image and the prediction error reproduced in step S702.

In step S805, the image decoding apparatus determines whether decoding is completed for all blocks. If decoding is completed for all blocks (YES in step S805), the image decoding apparatus ends the enhancement layer decoding processing. Otherwise (NO in step S805), the processing returns to step S801 to proceed to the following block.

With the above-described configurations and operations, in particular, the scaling processing based on the base layer prediction information in step S801 enables decoding the bit stream based on efficient inter-layer pixel prediction generated by the image encoding apparatus according to the first exemplary embodiment, thus acquiring a reproduction image.

An image decoding apparatus for the base layer and an image decoding apparatus for the enhancement layer may be separately provided. In this case, the scaling unit 608 may be provided outside.

Although, in the present exemplary embodiment, the prediction error is reproduced by the inverse transform units 604 and 610, the configuration is not limited thereto. For example, in a case where coded data is not quantized and where the prediction errors are PCM-coded as it is without transform, it is clear that the coded data can be decoded without using these processing units.

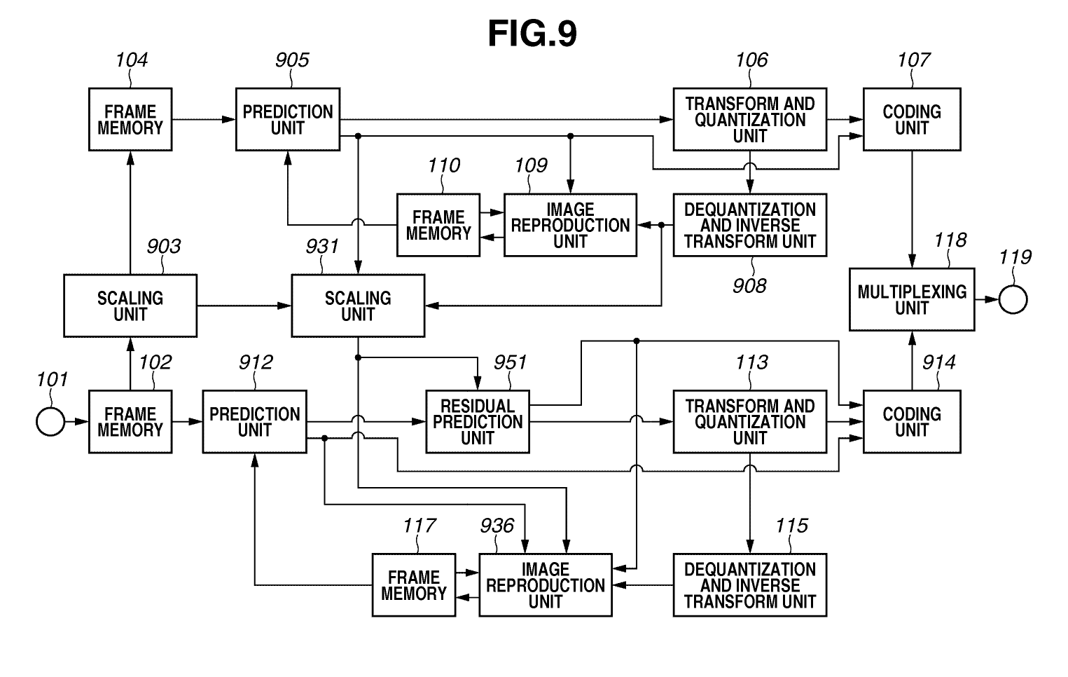

A third exemplary embodiment will be described below. FIG. 9 is a block diagram illustrating an image encoding apparatus according to the present exemplary embodiment. Referring to FIG. 9, elements having similar functions to those in the first exemplary embodiment illustrated in FIG. 1 are assigned the same reference numerals, and redundant descriptions thereof will be omitted.

A scaling unit 903 scales input image data at a scaling ratio of n/m (n and m are positive numbers) times. Unlike the scaling unit 103 illustrated in FIG. 1, the scaling unit 903 outputs the scaling ratio not to the scaling unit 111 which performs up-scaling processing on coded pixels but to the scaling unit 931 which up-scales the prediction errors. Similar to the dequantization and inverse transform unit 108 illustrated in FIG. 1, the dequantization and inverse transform unit 908 dequantizes the quantization coefficients output from the transform and quantization unit 106 to reproduce the transform coefficients, and inversely orthogonally transforms the transform coefficients to reproduce the prediction errors. Unlike the dequantization and inverse transform unit 108 in FIG. 1, the dequantization and inverse transform unit 908 outputs the reproduced prediction errors not only to the image reproduction unit 109 but also to the scaling unit 931.

Based on the prediction information output from a prediction unit 905, the scaling unit 931 scales the prediction error generated by the dequantization and inverse transform unit 908 at a scaling ratio of m/n times which is a reciprocal of that of the scaling unit 903. Then, the scaling unit 931 generates inter-layer residual prediction reference image data to be used for inter-layer residual prediction in the enhancement layer.

Similar to the prediction units 105 and 112 illustrated in FIG. 1, the prediction units 905 and 912 clip the image data in a plurality of blocks, and perform intra prediction (in-frame prediction) to generate the prediction image data. The prediction units 905 and 912 further calculate prediction errors based on the input image data and the generated prediction image data, and outputs the calculated prediction errors. Then, the prediction units 905 and 912 also output prediction information such as the intra prediction mode. Unlike the prediction unit 105 illustrated in FIG. 1, the prediction unit 905 outputs the prediction information not to the scaling unit 111 which performs up-scaling processing on coded pixels but to the scaling unit 931 which performs up-scaling processing on the prediction errors. Unlike the prediction unit 112 illustrated in FIG. 1, the prediction unit 912 does not perform inter-layer pixel prediction since inter-layer pixel prediction is not performed in the present exemplary embodiment. However, of course, inter-layer pixel prediction may be also applied.

A residual prediction unit 951 performs inter-layer residual prediction on the prediction errors generated by the prediction unit 912. When the residual prediction unit 951 determines that inter-layer residual prediction is to be used, the residual prediction unit 951 sets to the prediction errors differences between the prediction errors generated by the prediction unit 912 and the inter-layer residual prediction reference image data generated by the scaling unit 931 to update the prediction errors.

A coding unit 914 codes the quantization coefficients output from the transform and quantization unit 113, the prediction information output from the prediction unit 912, and the inter-layer residual prediction information output from the residual prediction unit 951 to generate coded data.

Based on the prediction information output from the prediction unit 912, the image reproduction unit 936 generates prediction image data suitably referring to the frame memory 117. When using inter-layer residual prediction, the image reproduction unit 936 adds the inter-layer residual prediction reference image data generated by the scaling unit 931 to the prediction errors generated by the dequantization and inverse transform unit 115 to update the prediction errors. Then, the image reproduction unit 936 generates reproduction image data based on the generated prediction image and the prediction errors, and outputs the generated reproduction image data.

Operations for coding an image by the image coding apparatus will be described below. Although, in the present exemplary embodiment, moving image data is input on a frame basis similar to the first exemplary embodiment, still image data for one frame may be input. Although, in the present exemplary embodiment, only intra prediction coding processing will be described below to simplify descriptions, the processing is not limited thereto. The present exemplary embodiment is also applicable to a case where inter prediction coding and intra prediction coding are used together. First of all, operations for coding the base layer image data will be described below.

The scaling unit 903 scales the image data stored in the frame memory 102 at a predetermined scaling ratio of n/m times, stores the scaled image data in the frame memory 104, and the scaling ratio is input to the scaling unit 931. The prediction unit 905 performs prediction on a block basis to generate prediction errors, and the generated prediction errors are input to the transform and quantization unit 106. The prediction information is input into the scaling unit 931, the image reproduction unit 109, and the coding unit 107. The dequantization and inverse transform unit 908 dequantize the input quantization coefficients to reproduce the transform coefficients, inversely orthogonally transforms the reproduced transform coefficients to reproduce the prediction errors, and outputs the reproduced prediction errors to the image reproduction unit 109 and the scaling unit 931.

Operations of the terminal 101, the frame memories 102, 104, and 110, the transform and quantization unit 106, the coding unit 107, and the image reproduction unit 109 are similar to those in the first exemplary embodiment, and redundant descriptions thereof will be omitted.

Operations for coding the enhancement layer image data will be described below.

Prior to inter-layer residual prediction by the residual prediction unit 951, prediction errors at a base layer block position corresponding to an enhancement layer block subjected to encoding is input into the scaling unit 931 from the dequantization and inverse transform unit 908. The scaling unit 931 scales the input base layer prediction errors at a scaling ratio of m/n times, and outputs the scaled prediction errors to the residual prediction unit 951 and the image reproduction unit 936 as inter-layer residual prediction reference image data to be used for inter-layer residual prediction. At this timing, the scaling ratio is input into the scaling unit 931 from the scaling unit 903, and the base layer block prediction information is input into the scaling unit 931 from the prediction unit 905, and the scaling unit 931 determines a filter to be used for the scaling processing. In the present exemplary embodiment, the scaling unit 931 determines a filter to be used for the scaling processing based on a similar method to that used by the scaling unit 111 illustrated in FIG. 1, and redundant descriptions will be omitted.

The prediction unit 912 applies block division to the image data stored in the frame memory 102, and performs intra prediction suitably referring to the frame memory 117 on a block basis to generate prediction errors. The generated prediction errors are input into the residual prediction unit 951, and the prediction information is input into the image reproduction unit 936 and the encoding unit 914.

The residual prediction unit 951 compares the prediction errors input from the prediction unit 912 with the inter-layer residual prediction reference image data generated by the scaling unit 931 to determine whether inter-layer residual prediction is to be used, and outputs the relevant information to the encoding unit 914 as inter-layer residual prediction information. When inter-layer residual prediction is to be used, the residual prediction unit 951 sets to the prediction errors differences between the prediction errors generated by the prediction unit 912 and the inter-layer residual prediction reference image data generated by the scaling unit 931 to update the prediction errors, and outputs the updated prediction errors to the transform and quantization unit 113. When inter-layer residual prediction is not to be used, the residual prediction unit 951 outputs to the transform and quantization unit 113 the prediction errors generated by the prediction unit 912 as they are.

The coding unit 914 entropy-codes the quantization coefficients generated by the transform and quantization unit 113, the prediction information input from the prediction unit 912, and the inter-layer residual prediction information input from the residual prediction unit 951 to generate coded data, and the generated coded data is input into the multiplexing unit 118.

Based on the prediction information input from the prediction unit 912, the image reproduction unit 936 reproduces the prediction image suitably referring to the frame memory 117. The inter-layer residual prediction information is input into the image reproduction unit 936 further inputs from the residual prediction unit 951. When inter-layer residual prediction is to be performed, the image reproduction unit 936 adds the inter-layer residual prediction reference image data generated by the scaling unit 931 to the prediction error input from the dequantization and inverse transform unit 115 to update the prediction errors. Then, the image reproduction unit 936 reproduces the image data based on the reproduced prediction image and the updated prediction errors, and the reproduced image data is input and stored in the frame memory 117.

Operations of the transform and quantization unit 113, the dequantization and inverse transform unit 115, the frame memory 117, the multiplexing unit 118, and the terminal 119 are similar to those in the first exemplary embodiment, and redundant descriptions will be omitted.

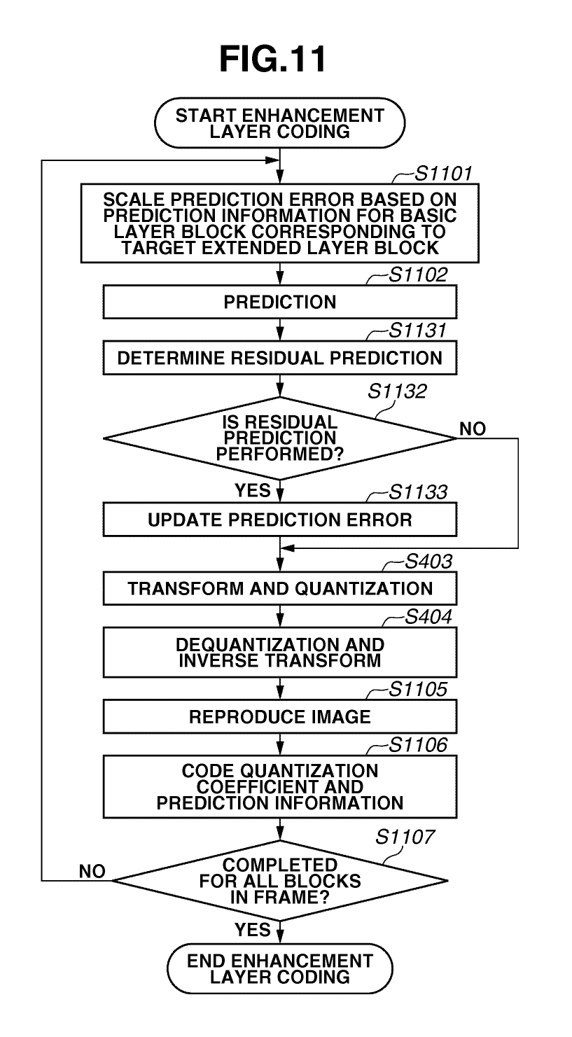

FIG. 11 is a flowchart illustrating enhancement layer coding processing by the image coding apparatus according to the third exemplary embodiment. The base layer coding processing in the present exemplary embodiment is similar to the base layer coding processing in the first exemplary embodiment, and redundant descriptions will be omitted. Referring to FIG. 11, elements having similar functions to those in the first exemplary embodiment illustrated in FIG. 4 are assigned the same reference numerals, and redundant descriptions thereof will be omitted.

In step S1101, based on the prediction mode for a base layer block corresponding to an enhancement layer block subjected to coding, the scaling unit 931 selects a filter to be used for the scaling processing. Then, by using the selected filter, the scaling unit 931 scales the prediction errors in the base layer block to generate inter-layer residual prediction reference image data for inter-layer residual prediction.

In step S1102, the prediction unit 912 clips the input image data in a plurality of blocks, applies intra prediction to the image data to generate prediction information and prediction image data, and calculates prediction errors based on the input image data and the generated prediction image data.

In step S1131, the residual prediction unit 951 compares the inter-layer residual prediction reference image data generated in step S1101 with the prediction errors generated in step S1102 to determine whether inter-layer residual prediction is to be used. In step S1132, the residual prediction unit 951 determines whether inter-layer residual prediction is to be used in the block subjected to coding. If inter-layer residual prediction is to be used (YES in step S1132), the processing proceeds to step S1133. Otherwise (NO in step S1132), the processing proceeds to step S403. In step S1133, the residual prediction unit 951 sets to the prediction errors difference between the prediction errors generated in step S1102 and the inter-layer residual prediction reference image data generated in step S1101 to update the prediction error.

In step S1105, the image reproduction unit 936 performs intra prediction or inter-layer pixel prediction based on the prediction information generated in step S1102 to reproduce the prediction image. The image reproduction unit 936 determines whether the prediction error reproduced in step S404 is to be updated depending on whether inter-layer residual prediction is performed in step S1131, and generates the relevant information as inter-layer residual prediction information. If inter-layer residual prediction is performed in step S1131, the image reproduction unit 936 adds the inter-layer residual prediction reference image data generated in step S1131 to the prediction error reproduced in step S404 to update the prediction errors. Then, the image reproduction unit 936 reproduces the image data based on the prediction image reproduced in step S1105 and the updated prediction errors.

In step S1106, the coding unit 914 codes the quantization coefficients generated in step S403, the prediction information generated in step S1102, and the inter-layer residual prediction reference image data generated in step S1131 to generate coded data.

Step S1106 may be executed in any order as long as it is executed after step S403.

In step S1107, the image coding apparatus determines whether coding is completed for all blocks. If coding is completed for all blocks (YES in step S1107), the image coding apparatus ends the enhancement layer coding processing. Otherwise (NO in step S1107), the processing returns to step S1101 to proceed to the following block. In a certain step (not illustrated), the multiplexing unit 118 multiplexes the base layer coded data generated in step S406 illustrated in FIG. 4 and the enhancement layer coded data generated in step S1106 based on a predetermined method to generate a bit stream.

With the above-described configurations and operations, in particular, the up-scaling processing based on the base layer prediction information in step S1101 enables using efficient inter-layer residual prediction for the enhancement layer, thus achieving high-efficient coding.

An image coding apparatus for the base layer and an image coding apparatus for the enhancement layer may be separately provided. In this case, the scaling units 903 and 931 may be provided outside, or the scaling unit 903 may be provided outside and the scaling unit 931 may be included in the image coding apparatus for the enhancement layer. In this case, images having a plurality of resolutions are input, images having a small resolution are input to the image coding apparatus for the base layer, and images having a large resolution are input to the image coding apparatus for the enhancement layer.

Although, in the present exemplary embodiment, inter-layer residual prediction is performed and inter-layer pixel prediction is not, inter-layer pixel prediction and inter-layer residual prediction may be simultaneously performed. In this case, a scaling unit having an equivalent function to the scaling unit 111 illustrated in FIG. 1 may be added, the scaling processing for inter-layer pixel prediction and inter-layer residual prediction may be independently controlled, and scaling processing may be performed by using an identical scaling filter and identical scaling unit 931.

Although, in the present exemplary embodiment, the amount of information of the prediction error is reduced by using the transform and quantization unit 106, the dequantization and inverse transform unit 908, the transform and quantization unit 113, and the dequantization and inverse transform unit 115, the configuration is not limited thereto. For example, quantization is not performed when the quantization parameter is 1, and the prediction errors may be PCM-coded as it is without transform.

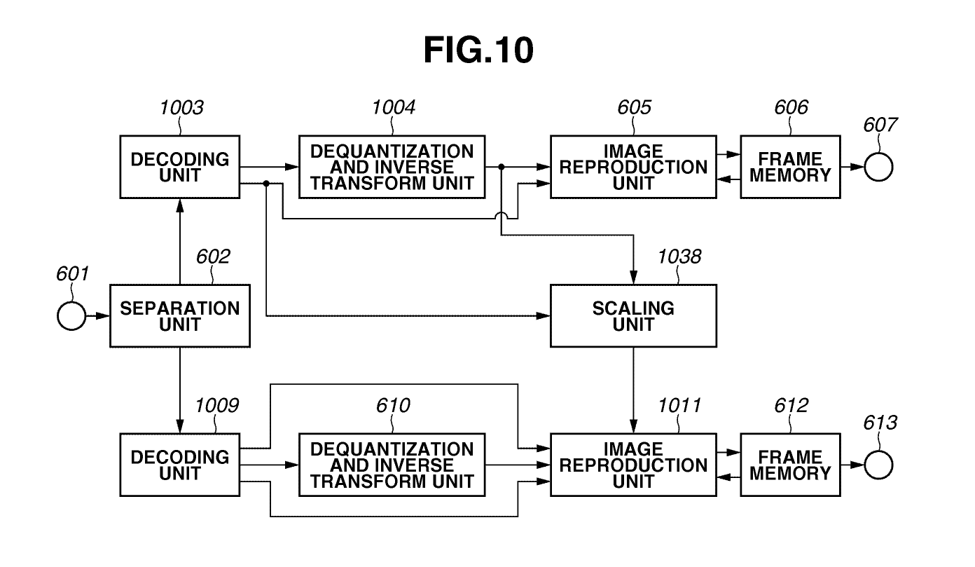

A fourth exemplary embodiment will be described below. FIG. 10 is a block diagram illustrating an image decoding apparatus according to the present exemplary embodiment. Referring to FIG. 10, elements having similar functions to those in the second exemplary embodiment illustrated in FIG. 6 are assigned the same reference numerals, and redundant descriptions thereof will be omitted.

The present exemplary embodiment will be described below centering on decoding of the coded data generated in the third exemplary embodiment.

Decoding units 1003 and 1009 separate coded data for each layer into coded data related to the quantization coefficients and coded data related to the prediction information, decode respective coded data to reproduce the quantization coefficients and prediction information, and output the reproduced quantization coefficients and prediction information to the later stage. The decoding unit 1009 further separates coded data related to the inter-layer residual prediction information, decodes the coded data to reproduce the inter-layer residual prediction information, and outputs the reproduced inter-layer residual prediction information to the later stage. The decoding units 1003 and 1009 perform inverse operations of the coding units 107 and 914 illustrated in FIG. 9, respectively.

Similar to the dequantization and inverse transform unit 604 illustrated in FIG. 6, a dequantization and inverse transform unit 1004 dequantizes the dequantization coefficient output from the decoding unit 1003 to reproduce the transform coefficients, and inversely orthogonally transforms the transform coefficients to reproduce the prediction errors. Unlike the dequantization and inverse transform unit 604 illustrated in FIG. 6, the dequantization and inverse transform unit 1004 outputs the reproduced prediction errors not only to the image reproduction unit 605 but also to the scaling unit 1038.

Similar to the image reproduction unit 936 illustrated in FIG. 9, based on the prediction information output from the decoding unit 1009, an image reproduction unit 1011 generates prediction image data suitably referring to the frame memory 612. Further, the prediction error is input into the image reproduction unit 1011 from the dequantization and inverse transform unit 610, and, based on the residual prediction information output from the decoding unit 1009, the image reproduction unit 1011 updates the prediction errors referring to the inter-layer residual prediction reference image data from the scaling unit 1038. The image reproduction unit 1011 further generates reproduction image data based on the updated prediction errors and prediction image data, and outputs the generated reproduction image data.

A scaling unit 1038 scales the base layer prediction errors according to the same scaling ratio as that of the scaling unit 931 illustrated in FIG. 9. A method for calculating the scaling ratio is not particularly limited. The scaling ratio may be calculated based on the ratio of the base layer resolution to the enhancement layer resolution, or on a predetermined setting value.

The decoding unit 1003, the dequantization and inverse transform unit 1004, the image reproduction unit 605, and the frame memory 606 decode the base layer coded data to reproduce the base layer image data. The decoding unit 1009, the dequantization and inverse transform unit 610, the image reproduction unit 1011, the frame memory 612, and the scaling unit 1038 decode the enhancement layer coded data to reproduce the enhancement layer image data.

Operations for decoding an image by the above-described image decoding apparatus will be described below. In the present exemplary embodiment, the image decoding apparatus decodes the bit stream generated in the third exemplary embodiment. Similar to the second exemplary embodiment, referring to FIG. 10, the bit stream input from the terminal 601 is input into the separation unit 602, separated into base layer coded data and enhancement layer coded data, and the base layer coded data is output to the decoding unit 1003 and the enhancement layer coded data is output to the decoding unit 1009.

First of all, operations for decoding the base layer coded data will be described below.

The base layer coded data is input into the decoding unit 1003, and the decoding unit 1003 decodes header information to separate the coded data into quantization coefficient coded data and prediction information coded data. Then, the decoding unit 1003 decodes respective coded data to reproduce the quantization coefficients and prediction information. The reproduced quantization coefficients are input into the dequantization and inverse transform unit 1004, and the reproduced prediction information is input into the image reproduction unit 605 and the scaling unit 1038.

The dequantization and inverse transform unit 1004 dequantizes the input quantization coefficients to generate orthogonal transform coefficients and inversely orthogonally transforms the transform coefficients to reproduce the prediction errors. The reproduced prediction errors are input into the image reproduction unit 605 and the scaling unit 1038.

The image reproduction unit 605, the frame memory 606, and the terminal 607 operate in similar ways to those in the second exemplary embodiment, and redundant descriptions thereof will be omitted.

Operations for decoding the enhancement layer coded data will be described below. Prior to the inter-layer residual prediction in the image reproduction unit 1011, the prediction errors at a base layer block position corresponding to an enhancement layer block subjected to decoding is input into the scaling unit 1038 from the dequantization and inverse transform unit 1004. The scaling unit 1038 scales the input prediction errors at a scaling ratio of n/m times, and outputs the scaled prediction errors to the image reproduction unit 1011 as inter-layer residual prediction reference image data. At this timing, the base layer block prediction information is input into the scaling unit 1038 from the decoding unit 1003, and, similar to the scaling unit 931 illustrated in FIG. 9 in the third exemplary embodiment, the scaling unit 1038 determines a filter to be used for the scaling processing based on the input prediction information.

The enhancement layer coded data is input into the decoding unit 1009, and the decoding unit 1009 decodes header information to separate the coded data into quantization coefficient coded data, prediction information coded data, and inter-layer residual prediction information coded data. Then, the decoding unit 1009 decodes respective coded data to reproduce the quantization coefficients, the prediction information, and the inter-layer residual prediction information. The reproduced quantization coefficients are input into the dequantization and inverse transform unit 610, and the reproduced prediction information and inter-layer residual prediction information is input into the image reproduction unit 1011.

Based on the prediction information input from the decoding unit 1009, the image reproduction unit 1011 reproduces the prediction image suitably referring to the frame memory 612. In the meantime, based on the inter-layer residual prediction information input from the decoding unit 1009, the image reproduction unit 1011 updates the prediction errors input from the dequantization and inverse transform unit 610. If inter-layer residual prediction is to be used in the block subjected to decoding, the image reproduction unit 1011 adds the inter-layer residual prediction reference image data generated by the scaling unit 1038 to the prediction errors input from the dequantization and inverse transform unit 610 to update the prediction errors as new prediction errors. If inter-layer residual prediction is not to be used, the image reproduction unit 1011 uses the prediction errors input from the dequantization and inverse transform unit 610 as they are. Then, the image reproduction unit 1011 reproduces the image data based on the input prediction errors and the reproduced prediction image, and inputs and stores the image data in the frame memory 612. The stored image data is used for reference during prediction, in the mean time, the stored image data is output as the enhancement layer image data from the terminal 613.

The dequantization and inverse transform unit 610 operates in a similar way to that in the second exemplary embodiment, and redundant descriptions thereof will be omitted.

Processing for decoding the bit stream by the image decoding apparatus according to the fourth exemplary embodiment will be described below. Similar to the second exemplary embodiment, prior to processing, in a certain step (not illustrated), the separation unit 602 divides the input bit stream into base layer coded data and enhancement layer coded data. The base layer coded data is decoded by the base layer decoding processing (described below), and the enhancement layer coded data is decoded by the enhancement layer decoding processing (described below).

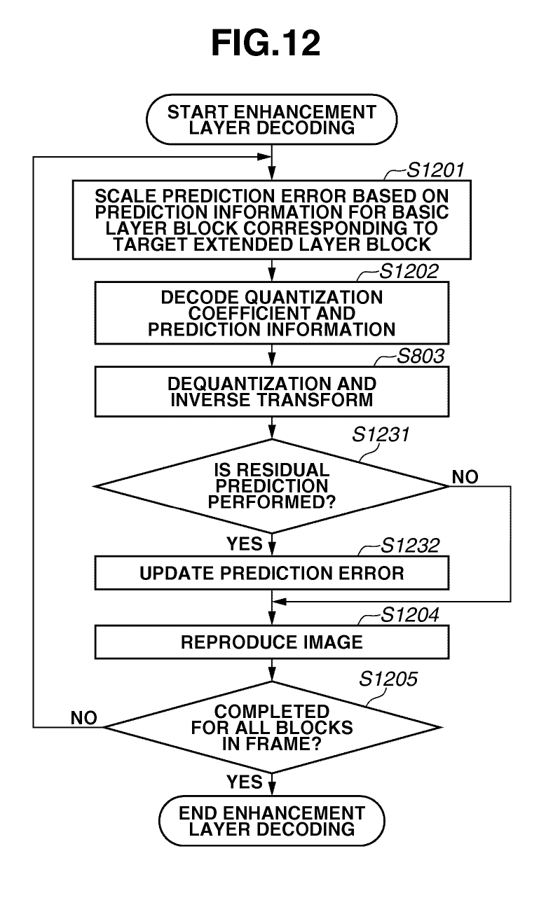

FIG. 12 is a flowchart illustrating the enhancement layer decoding processing by the image decoding apparatus according to the fourth exemplary embodiment. The base layer decoding processing according to the present exemplary embodiment is similar to the base layer decoding processing according to the second exemplary embodiment, and redundant descriptions will be omitted. Referring to FIG. 12, elements having similar functions to those in the second exemplary embodiment illustrated in FIG. 8 are assigned the same reference numerals, and redundant descriptions thereof will be omitted.

In step S1201, the scaling unit 1038 selects a filter to be used for the scaling processing based on the prediction mode for a base layer block corresponding to an enhancement layer block subjected to coding. Then, by using the selected filter, the scaling unit 1038 scales the prediction errors in the base layer block to generate inter-layer residual prediction reference image data for inter-layer residual prediction. In step S1202, the decoding unit 1009 decodes the enhancement layer coded data to reproduce the quantization coefficients, the prediction information, and the inter-layer residual prediction information.

In step S1231, based on the inter-layer residual prediction information reproduced in step S1202, the image reproduction unit 1011 determines whether inter-layer residual prediction is to be used in the block subjected to encoding. If inter-layer residual prediction is to be performed (YES in step S1231), the processing proceeds to step S1232. Otherwise (NO in step S1231), the processing proceeds to step S1204.

In step S1232, the image reproduction unit 1011 adds the inter-layer residual prediction reference image data generated in step S1201 to the prediction errors reproduced in step S803 to update the prediction errors as new prediction errors. In step S1204 (when inter-layer residual prediction is not to be performed and the prediction errors reproduced in step S803 are used as they are), the image reproduction unit 1011 performs prediction based on the prediction information reproduced in step S1202 to reproduce the prediction image, and reproduces the image data based on the reproduced prediction errors and the prediction image reproduced in this step.

In step S1205, the image decoding apparatus determines whether decoding is completed for all blocks. If decoding is completed for all blocks (YES in step S1205), the image decoding apparatus ends the enhancement layer decoding processing. Otherwise (NO in step S1205), the processing returns to step S1201 to proceed to the following block.

With the above-described configurations and operations, in particular, the scaling processing based on the base layer prediction information in step S1201 enables decoding the bit stream based on efficient inter-layer residual prediction generated by the image encoding apparatus according to the third exemplary embodiment, thus acquiring a reproduction image.

Although, in the present exemplary embodiment, the scaling unit 608 sets a predetermined scaling ratio, the processing is not limited thereto. The scaling ratio may be separately calculated based on the ratio of the base layer resolution to the enhancement layer resolution.

An image decoding apparatus for the base layer and an image decoding apparatus for the enhancement layer may be separately provided. In this case, the scaling unit 608 may be provided outside. Although, in the present exemplary embodiment, inter-layer residual prediction is performed and inter-layer pixel prediction is not, inter-layer pixel prediction and inter-layer residual prediction may be simultaneously performed. In this case, a scaling unit having an equivalent function to the scaling unit 608 illustrated in FIG. 6 may be added, the scaling processing for inter-layer pixel prediction and inter-layer residual prediction may be independently controlled, and identical scaling processing may be performed by using identical scaling unit 1038.

Although, in the present exemplary embodiment, the prediction errors are reproduced by using the dequantization and inverse transform units 1004 and 610, the configuration is not limited thereto. For example, in a case where coded data is not quantized and where the prediction errors are PCM-coded as they are without transform, it is clear that the coded data can be decoded without using these processing units.

A fifth exemplary embodiment will be described below. The above-described exemplary embodiment is described to include hardware-based processing units illustrated in FIGS. 1, 6, 9, and 10. However, processing performed by these processing units may be configured by a computer program.

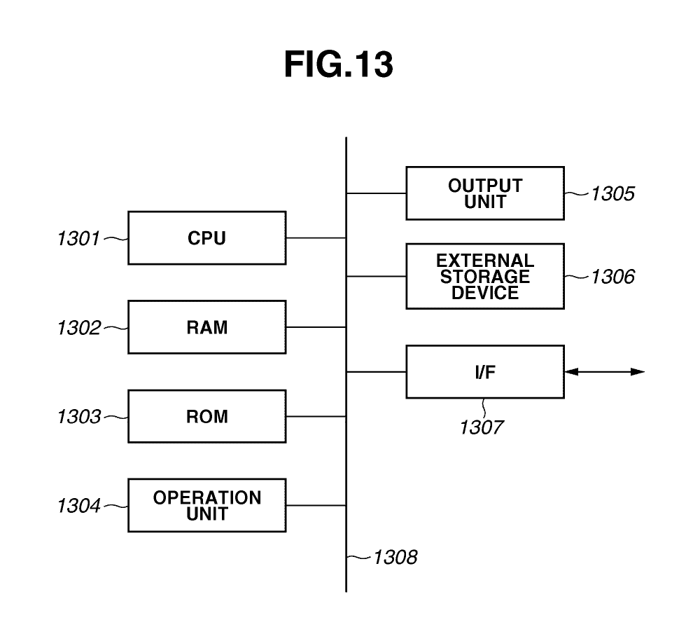

FIG. 13 is a block diagram illustrating an example of a hardware configuration of a computer applicable to an image display apparatus according to the above-described exemplary embodiments.

By using computer programs and data stored in a random access memory (RAM) 1302 and a read-only memory (ROM) 1303, a central processing unit (CPU) 1301 controls the entire computer, and executes the above-described each processing which is to be performed by the image processing apparatuses according to the above-described exemplary embodiments. In other words, the CPU 1301 functions as each of the processing units illustrated in FIGS. 1, 6, 9, and 10.

The RAM 1302 includes an area for temporarily storing a computer program and data loaded from an external storage device 1306, and data acquired from outside via an interface (I/F) 1309. The RAM 1302 further includes a work area used by the CPU 1301 to execute various processing. In other words, the RAM 1302 can be assigned, for example, as a frame memory, and enables suitably providing various types of areas.

The ROM 1303 stores setting data and a boot program for the computer. An operation unit 1304 including a keyboard, a mouse, etc. allows a user of the computer to operate the keyboard and the mouse to input various instructions to the CPU 1301. A display unit 1305 displays a result of processing by the CPU 1301. The display unit 1305 includes, for example, a liquid crystal display (LCD).

The external storage device 1306 is a mass storage device represented by a hard disk drive apparatus. The external storage device 1306 stores an operating system (OS) and computer programs for causing the CPU 1301 to implement functions of each of the processing units illustrated in FIGS. 1, 6, 9, and 10. The external storage device 1306 further stores image data as data subjected to processing.

The computer programs and data stored in the external storage device 1306 are suitably loaded into the RAM 1302 under control of the CPU 1301, and processed by the CPU 1301. A network such as a local area network (LAN) and the Internet, a projection apparatus, a display apparatus, and other apparatuses can be connected to an interface (I/F) 1307. The computer can acquire and send various information via the I/F 1307. A bus 1308 connects the above-described processing units.

To implement operations of the thus-configured processing units, the CPU 1301 serves as a center to control the operations described in the above-described flowcharts.

Other exemplary embodiments will be described below. The present invention is also achieved when a storage medium storing computer program codes for implementing the above-described functions is supplied to a system, and the system reads and executes the computer program codes. In this case, the computer program codes read from the storage medium implement functions of the above-described exemplary embodiments, and the storage medium storing the computer program codes constitutes the present invention. The present invention includes a case where the OS operating on the computer partially or entirely executes actual processing based on instructions of the program codes and the above-described functions are implemented by the processing.

The present invention may be also achieved in the following form. Specifically, the present invention includes a case where a computer program code is read from a storage medium and then stored in a memory included in a function extension card inserted into the computer or a function extension unit connected thereto, and, a CPU included in the function extension card or the function extension unit partially or entirely executes actual processing based on instructions of the computer program code to implement any of the above-described functions.

When the present invention is applied to the above-described storage media, the storage media store the computer program codes corresponding to the processing of the above-described flowcharts.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-252924 filed Nov. 18, 2011, which is hereby incorporated by reference herein in its entirety.

What is claimed is:

1. An image coding apparatus comprising:
a first coding unit configured to be input with an image having a first resolution, and, on a block basis, perform prediction of a block subjected to coding based on coded pixels to code the image and generate first prediction information indicating a prediction method;
a scaling unit configured to scale a first image output from the first coding unit based on a ratio of the first resolution to a second resolution larger than the first resolution, by using a filter determined by the first prediction information, to generate inter-layer pixel prediction reference data; and
a second coding unit configured to be input with an image having the second resolution, and, on a block basis, perform prediction based on coded pixels or the inter-layer pixel prediction reference data to code the image.

2. The image coding apparatus according to claim 1, wherein the first prediction information indicates a direction of intra prediction of a block of the image having the first resolution.

3. The image coding apparatus according to claim 2, wherein the scaling unit scales the first image by using any one of filters having different numbers of taps, depending on the direction of intra prediction of a block of the image having the first resolution indicated by the first prediction information.

4. The image coding apparatus according to claim 3, wherein the scaling unit scales the first image by using a filter which preserves an edge in a direction parallel to the direction of intra prediction of a block of the image having the first resolution.

5. The image coding apparatus according to claim 3, wherein, depending on the direction of intra prediction of a block of the image having the first resolution indicated by the first prediction information, the scaling unit uses a filter having a small number of taps for filtering with an angle parallel to or close to the direction of intra prediction, and a filter having a large number of taps for filtering with an angle perpendicular to or close to the direction of intra prediction.

6. An image decoding apparatus for being input with a bit stream including a coded image having a first resolution and a coded image having a second resolution larger than the first resolution, and decoding the bit stream, the image decoding apparatus comprising:
a first decoding unit configured to decode first coded data corresponding to the image having the first resolution, and decode first prediction information indicating a prediction method;
a scaling unit configured to scale a first image output from the first decoding unit based on a ratio of the first resolution to the second resolution, by using a filter determined by the first prediction information, to generate inter-layer pixel prediction reference data; and
a second decoding unit configured to decode second coded data corresponding to the image having the second resolution based on the inter-layer pixel prediction reference data.

7. A method for coding an image by an image coding apparatus, the method comprising:
performing first coding configured to be input with an image having a first resolution, and, on a block basis, perform prediction of a block subjected to coding based on coded pixels to code the image and generate first prediction information indicating a prediction method;
scaling a first image output from the first coding unit based on a ratio of the first resolution to a second resolution larger than the first resolution, by using a filter determined by the first prediction information, to generate inter-layer pixel prediction reference data; and
performing second coding configured to be input with an image having the second resolution, and, on a block basis, perform prediction based on coded pixels or the inter-layer pixel prediction reference data to code the image.

8. A method for decoding an image by an image decoding apparatus for being input with a bit stream including a coded image having a first resolution and a coded image having a second resolution larger than the first resolution, and decoding the bit stream, the method comprising:
performing a first decoding configured to decode first coded data corresponding to the image having the first resolution, and decoding first prediction information indicating a prediction method;
scaling the first image output from a first decoding unit based on a ratio of the first resolution to the second resolution, by using a filter determined by the first prediction information, to generate inter-layer pixel prediction reference data; and
performing a second decoding configured to decode second coded data corresponding to the image having the second resolution based on the inter-layer pixel prediction reference data.

9. A computer-readable storage medium storing a program for causing a computer to function as the coding apparatus according to claim 1.

10. A computer-readable storage medium storing a program for causing a computer to function as the decoding apparatus according to claim 6.
